(19) United States
(12) Patent Application Publication
(10) Pub. No.: US 2011/0288244 A1
(43) Pub. Date: Nov. 24, 2011

(54) PHOSPHORUS-FUNCTIONALIZED POLY(ARYL ETHER KETONE)S AND THEIR PREPARATION PROCESS AND USE

(75) Inventors: Ching-Hsuan Lin, Taichung City (TW); Tsai Pei Wei, Taichung City (TW); Sheng Lung Chang, Taichung City (TW)

(73) Assignee: National Chung Hsing University, Taichung City (TW)

(21) Appl. No.: 13/112,756

(22) Filed: May 20, 2011

(30) Foreign Application Priority Data
May 21, 2010 (TW) 099116404

(51) Int. Cl. C08G 8/28

(52) U.S. Cl. 525/471

(57) ABSTRACT

A phosphorus functionalized poly(aryl ether ketone) developed by using 9,10-dihydro-9-oxa-10-phosphaphenanthrene 10-oxide (DOPO) to modify a poly(aryl ether ketone) is provided. The phosphorus functionalized poly(aryl ether ketone) can include reactive functional groups, such as hydroxy, amino, and carboxyl groups for further modification.

### FIELD OF THE INVENTION

The present invention relates to a poly(aryl ether ketone), and more particularly, to a phosphorus-functionalized poly(aryl ether ketone) that introduces a phosphorus-containing component into a poly(aryl ether ketone) polymer to improve the flame resistance of the polymer.

### DESCRIPTION OF THE RELATED ART

In 1980, an England company, ICI, for the first time successfully developed a semi-crystalline, non-transparent, linear aromatic polymer poly(ether ether ketone) (PEEK). To sell this product, ICI started up a new company, Victrex, in 1993 and merchandised the product with a trade name of Victrex PEEK™. Victrex was the only company manufacturing PEEK around the world at that time. Nowadays, PEEK has become and been recognized a valued, high quality commercial engineering thermal plastic, composed by the repeating units of three phenyl rings, two ether groups, and one ketone group. The structure can be represented by the following formula.

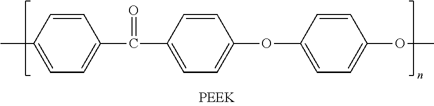

Except PEEK, there are many other aromatic poly(aryl ether ketone)s, such as poly(ether ketone)(PEK) or poly(ether ketone ketone)(PEKK), which can be represented by the formulas of:

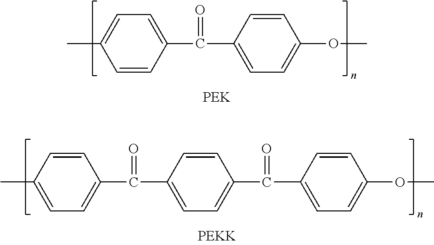

Aromatic poly(aryl ether ketone)s have superior heat-resistant property, and advantages of anti-abrasion, anti-chemical, anti-hydrolysis and easy-processing. Therefore, they are widely applied since the day of being merchandised. However, there is an improvement potential in flame-resistance.

Industrial or academic researchers have tried to improve the flame-resistant property of poly(aryl ether ketone) for years. For example, compounds containing organic phosphorus have been found that they can improve the flame-resistant property of a polymer. In addition, compounds containing phosphorus have been found that they produce less toxic gases in comparison with the retardants containing halogen, and have advantages of fewer used amounts and less fuming. Phosphorus-containing compound 9,10-dihydro-9-oxa-10-phosphaphenanthrene 10-oxide (DOPO) is preferred one. DOPO is a reactant having an active hydrogen atom to process addition reaction with compounds lack of electrons, such as benzoquinone, oxirane, maleic acid, bismaleimide, diaminobenzophenone, or terephthaldicarboxaldehyde to form a phosphorus-containing compound. Its derivatives are drawing industrial or academic researchers' attention.

Related researches, for example, include the phosphorus-containing PEEK polymer successfully developed by T. Hoffmann in 2005. T. Hoffmann studied the thermal properties and the flame-resistant property of the polymer with differential scanning calormetry (DSC), thermogravimetric analysis (TGA) and Limiting Oxygen Index (LOI). The results showed that the phosphorus-containing poly(aryl ether ketone) has superior heat-resistant and flame-resistant properties. The suggested synthesis scheme is as follows.

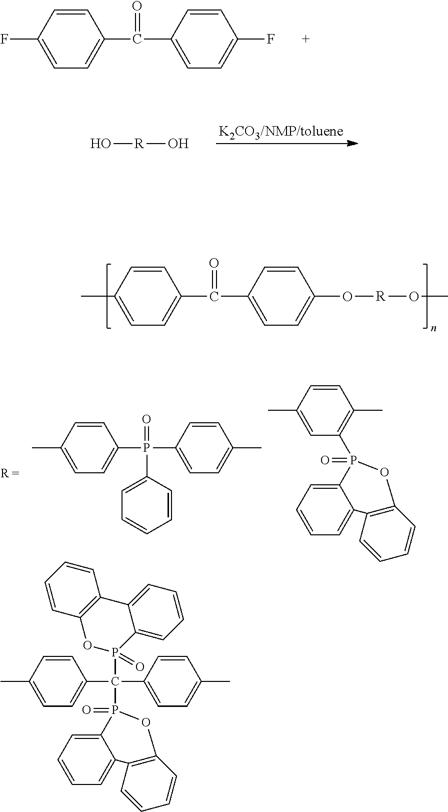

It is found from the above example that the phosphorus-containing derivatives have advantages of heat-resistance and flame-resistance and simultaneously preserve the advantages residing in the polymer if they are introduced into the polymer. If reactive functional groups can be introduced into the polymer chain, an advantageously further modified polymer can be produced.

In view of the above concept, the present invention provides a phosphorus-containing poly(aryl ether ketone), which not only exhibits superior mechanical and heat-resistant properties but also provides the industry opportunity for further modifications.

### REFERENCES

[1] T. Hoffmann, D. Pospiech, L. Muffler, H. Komber, D. Voigt, C. Harnisch, C. Kollann, M. Ciesielski, M. Doring, R. P. Graterol, J. Sandler, V. Altstädt. Macromol. Chem. Phys. 2005, 206, 423.
[2] Wang, C. S.; Lin, C. H. Polymer 1999; 40; 747
[3] Lin, C. H.; Wang, C. S. Polymer 2001, 42, 1869
[4] Wang, C. S.; Lin, C. H.; Wu, C. Y. J. Appl. Polym. Sci. 2000, 78, 228
[5] Lin, C. H.; Wang, C. S. J. Polym. Sci. Part A: Polym. Chem. 2000, 38, 2260.
[6] Liu, Y. L.; Tsai, S. H. Polymer 2002, 43, 5757
[7] Wu, C. S.; Liu, Y. L.; Chiu, Y. S. Polymer 2002, 43, 1773
[8] Liu, Y. L.; Wu, C. S.; Hsu, K. Y.; Chang, T. C. J. Polym. Sci. Part A: Polym Chem. 2002, 40, 2329

### BRIEF SUMMARY OF THE INVENTION

One object of the present invention is to provide a phosphorus-functionalized poly(aryl ether ketone), exhibiting superior heat resistant and flame resistant properties and mechanical properties as well.

Another object of the present invention is to provide a phosphorus-functionalized poly(aryl ether ketone), including specific functional groups for further modifications.

Another object of the present invention is to provide a process for preparing a phosphorus-functionalized poly(aryl ether ketone), which can be carried out by simple steps.

### BRIEF DESCRIPTION OF THE DRAWINGS

FIG. 1 is a NMR spectrum of P-BPAPEEK-A (H).

FIG. 2 is a NMR spectrum of P-BPAPEEK-A (P).

FIG. 3 is an IR spectrum of P-BPAPEEK-A.

### DETAILED DESCRIPTION OF THE INVENTION

In the specification and claims, the singular forms “a,” “an,” and “the” include the plural unless the context clearly dictates otherwise. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Phosphorus-Functionalized Poly(aryl ether ketone)

The present invention discloses a phosphorus-functionalized poly(aryl ether ketone), having the following chemical formula (I):

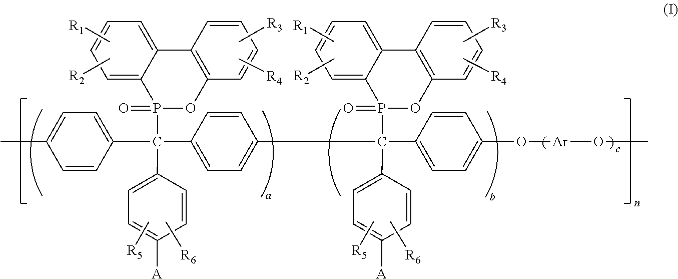

wherein a, b, c independently to each other is an integer of 0 to 3; n is an integer of 10 to 300; Ar is di-substituted phenyl ring or naphthalene;

R₁ to R₆ independently to each other are selected from a group consisting of H, C₁-C₆alkyl, C₁-C₆alkoxy, C₃-C₇cycloalkyl, phenyl, nitro, phenoxy, C₁-C₁₀haloalkyl, —CF₃, —OCF₃, and halo atom;

A is selected from the group consisting of —OH, —NH₂, —OCH₃, C₁-C₆alkyl, C₁-C₆alkoxy, C₁-C₁₀haloalkyl, C₃-C₇cycloalkyl, —CF₃, —OCF₃, halo atom, —NHR₁, —NH(C═O)—R₁, —NH(O═C—O)—R₁, —NH(O═C—NH)—R₁,

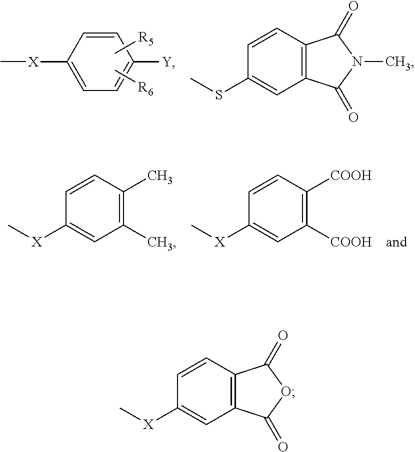

X is —O— or —NH—; and

Y is selected from the group consisting of hydrogen atom, —NO₂, —OH, —NH₂, —COOH, C₁-C₆alkyl, C₁-C₆alkoxy, C₃-C₇cycloalkyl, —CF₃, —OCF₃, and halo atom.

According to the present invention, the phosphorus-containing poly(aryl ether ketone) of the formula (I) can be categorized as follows by the selected poly(ether ketone) and the compound containing the phenyl ring.

In the compound of formula (I), if a=1, b=0, c=1,

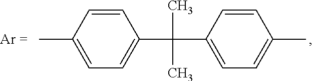

a phosphorus-functionalized poly(aryl ether ketone) having the formula (II) can be obtained. This kind of phosphorus-functionalized poly(aryl ether ketone) can be named as P-BPAPEEK series.

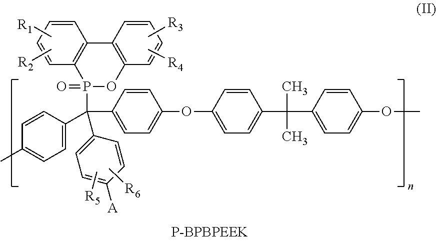

In the compound of formula (I), if a=1, b=0, c=1,

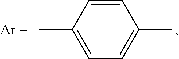

a phosphorus-functionalized poly(aryl ether ketone) having the formula (III) can be obtained. This kind of phosphorus-functionalized poly(aryl ether ketone) can be named as P-PEEK series.

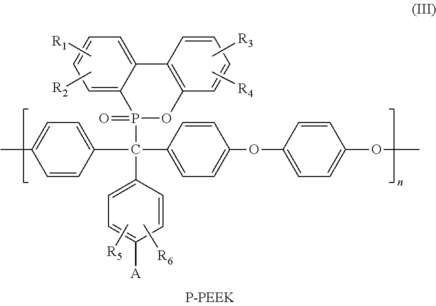

In the compound of formula (I), if a=1, b=0, c=0, a phosphorus-functionalized poly(aryl ether ketone) having the formula (IV) can be obtained. This kind of phosphorus-functionalized poly(aryl ether ketone) can be named as P-PEK series.

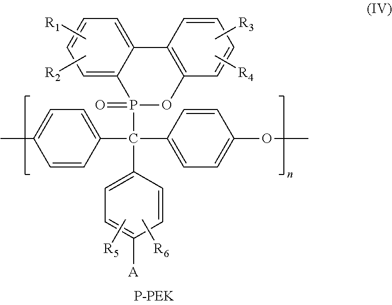

In the compound of formula (I), if a=1, b=1, c=0, a phosphorus-functionalized poly(aryl ether ketone) having the formula (V) can be obtained. This kind of phosphorus-functionalized poly(aryl ether ketone) can be named as P-PEKK series.

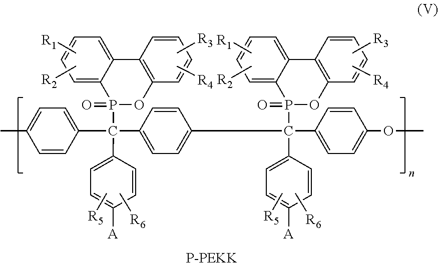

Specifically, in the P-BPAPEEK series of phosphorus-functionalized poly(aryl ether ketone) in which each R₁-R₆ is hydrogen,
(a) if A is —OH, the compound of formula (II) is P-BPAPEEK-A; or

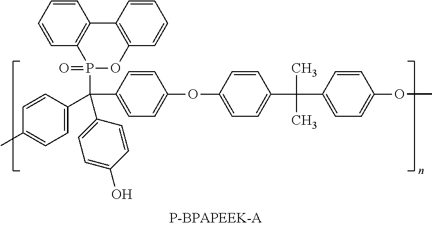

(b) if A is —NH₂, the compound of formula (II) is P-BPAPEEK-B; or

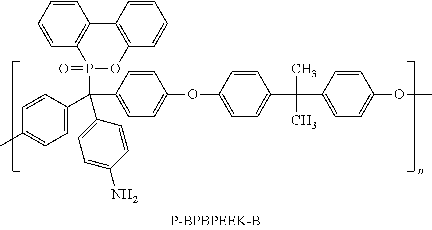

(c) if A is —OCH₃, the compound of formula (II) is P-BPAPEEK-C.

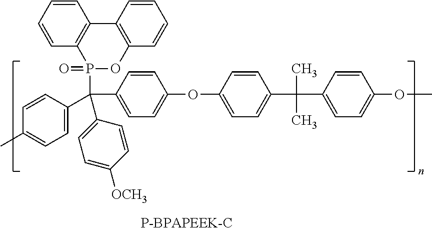

More specifically, in the P-PEEK series of phosphorus-functionalized poly(aryl ether ketone) in which each R₁-R₆ is hydrogen,
(a) if A is —OH, the compound of formula (III) is P-PEEK-A; or

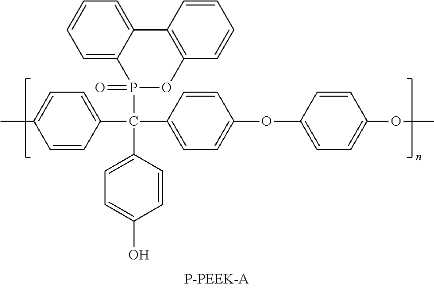

(b) if A is —NH₂, the compound of formula (III) is P-PEEK-B; or

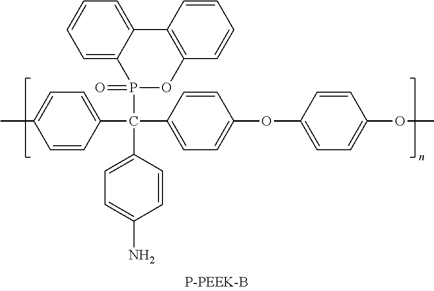

(c) if A is —OCH₃, the compound of formula (III) is P-PEEK-C.

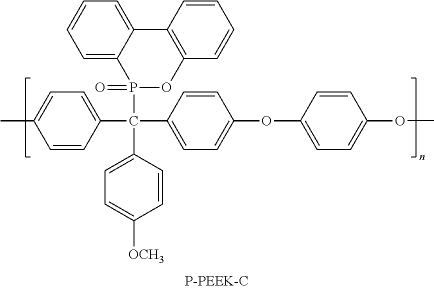

Given the above, since the precursor of the present invention can be poly(aryl ether ketone) polymer, such as PEK, PEEK, or PEKK, the phosphorus-functionalized poly(aryl ether ketone) of the present invention not only can provide specific functional groups for further modifications, but also can preserve the superior mechanical property and the heat-resistant and flame-resistant properties as well.

Process for Preparing A Phosphorus-Functionalized Poly(aryl ether ketone)

The present invention provides a process for preparing the above phosphorus-functionalized poly(aryl ether ketone) of formula (I), including: processing addition reaction through carbonyl of a poly(aryl ether ketone) polymer; and processing condensation reaction with a substituted or unsubstituted compound having phenyl ring upon catalysis of an acid to form the phosphorus-functionalized poly(aryl ether ketone) of formula (I), whereby the functional groups are introduced into the polymer chain to form a polymer such as the compound of formula (II), (III), (IV) or (V) for further modifications.

The present invention further provides a process for preparing the phosphorus-functionalized poly(aryl ether ketone) of formulas (II), (III), (IV), or (V), including reacting poly(aryl ether ketone) of formula (X), organic phosphide of formula (XI), a compound of formula (XII), and a catalyst to form the phosphorus-functionalized poly(aryl ether ketone) of formula (II), (III), (IV), or (V);

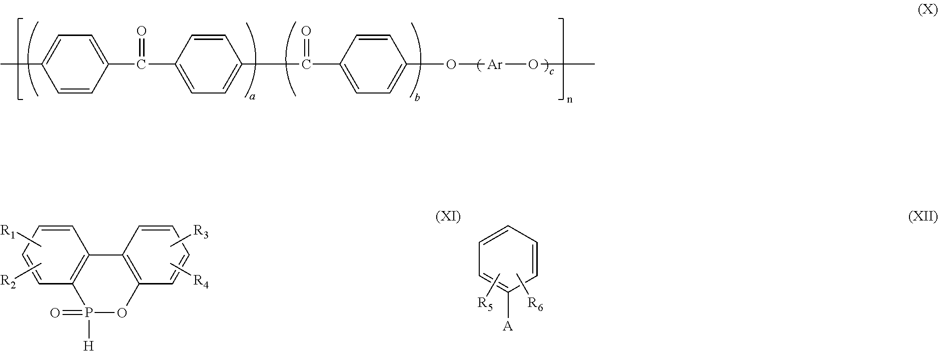

wherein a, b, c, n, Ar, R₁ to R₆, and A are defined as above.

The specific reaction schemes of P-BPAPEEK series of formula (II), P-PEEK series of formula (III), P-PEK series of formula (IV), and P-PEKK series of formula (V) of the phosphorus-functionalized poly(aryl ether ketone) are shown as follows respectively.

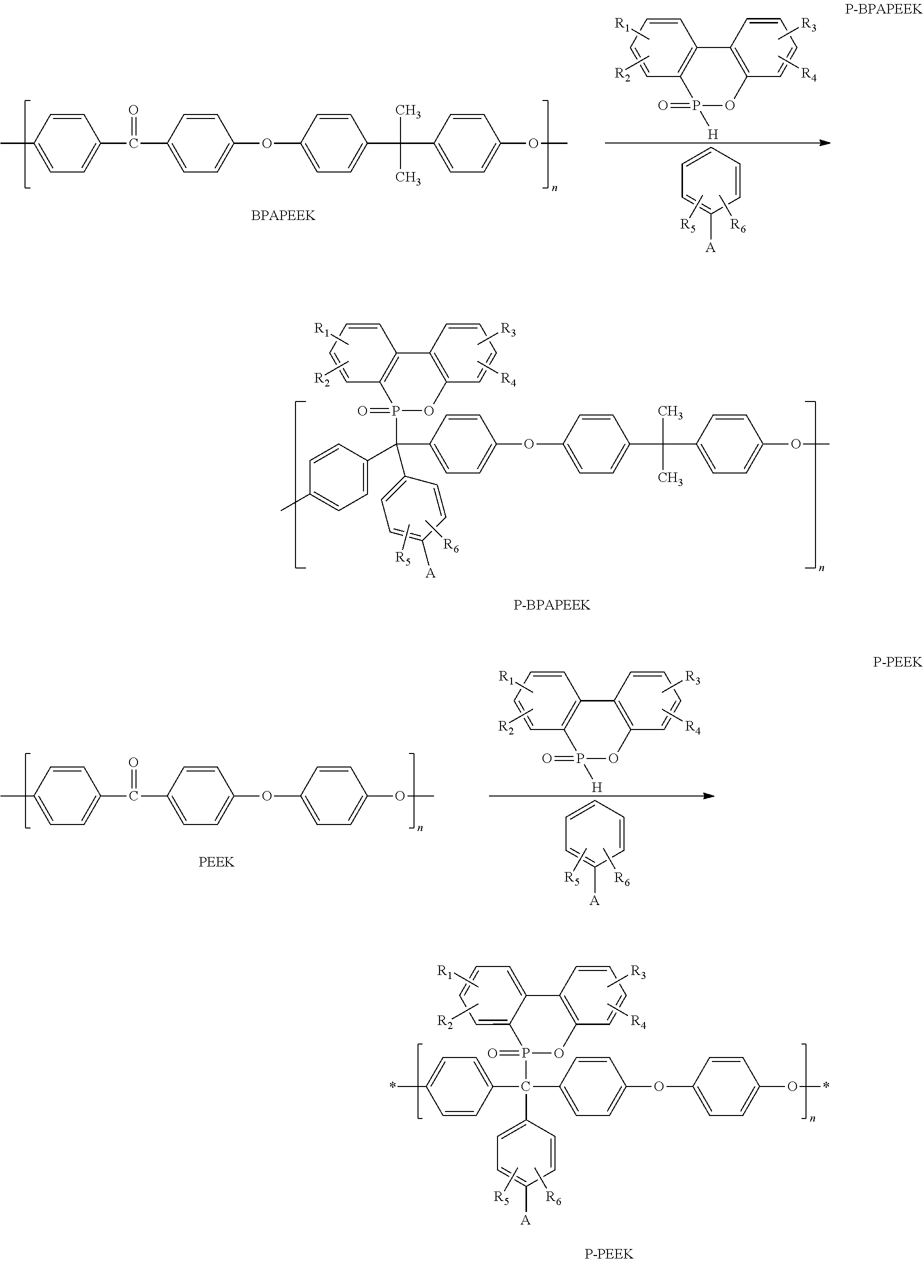

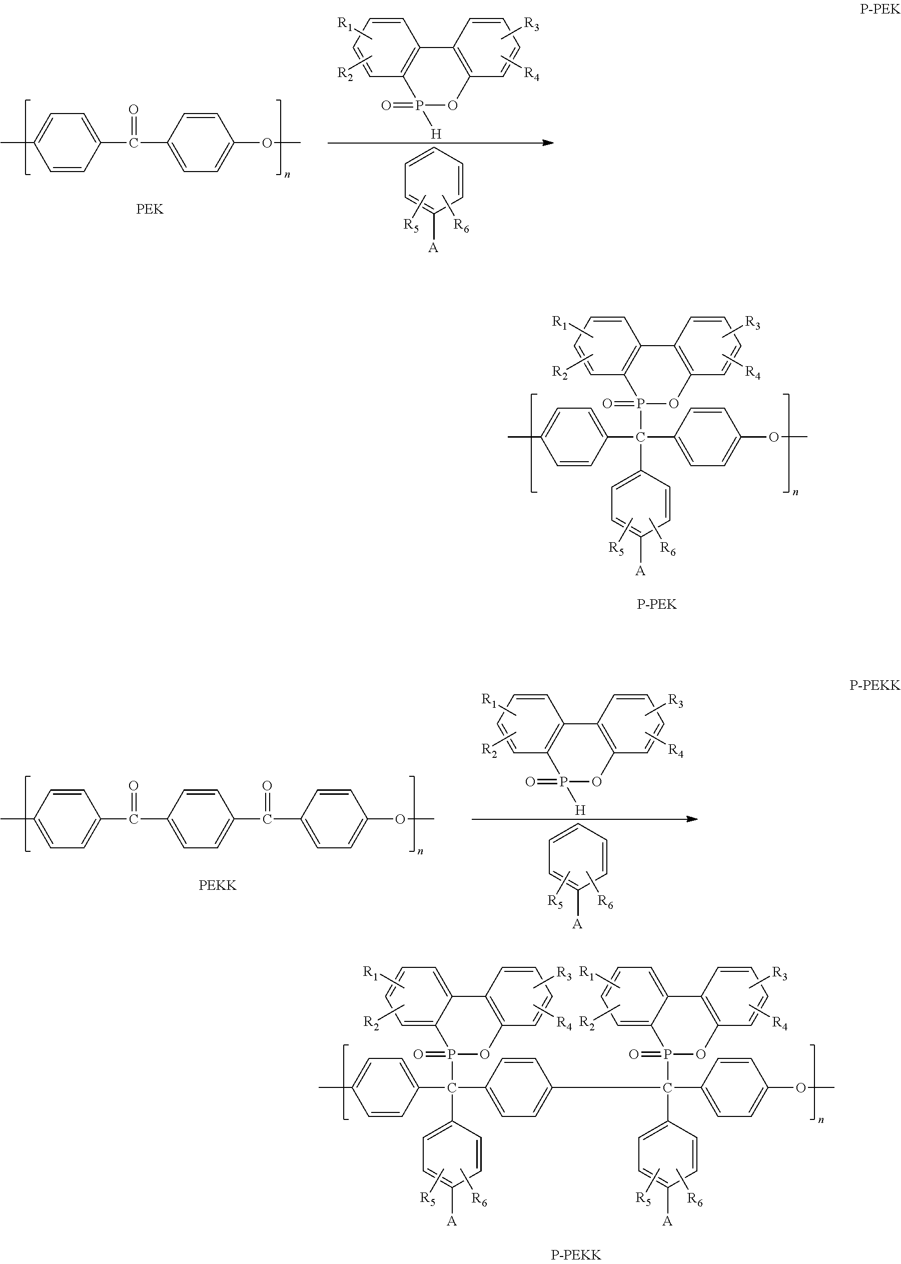

The acid catalyst used in the above reaction can be organic or inorganic acids such as oxalic acid, acetic acid, p-toluenesulfonic acid, methanesulfonic acid, sulfuric acid, orthanilic acid, 3-pyridinesulfonic acid, sulfanilic acid, hydrogen chloride (HCl), hydrogen bromide (HBr), hydrogen iodide (HI), hydrogen floride (HF), trifluoracetic acid (CF₃COOH), nitric acid (HNO₃), or phosphoric acid.

The above reaction can be carried out at a temperature about 105 to 155° C. The reaction time is about 10 to 14 hours.

In view of the above, if a phosphorus-containing poly(aryl ether ketone) including a phenol group (P-BPAPEEK-A) is desired, the process for example includes the steps of:
(1) reacting bisphenol-A with 4,4′-difluorobenzophenone to form BPAPEEK; and
(2) reacting BPAPEEK, DOPO, and excess phenol upon the catalysis of acids.
   The reaction scheme can be:

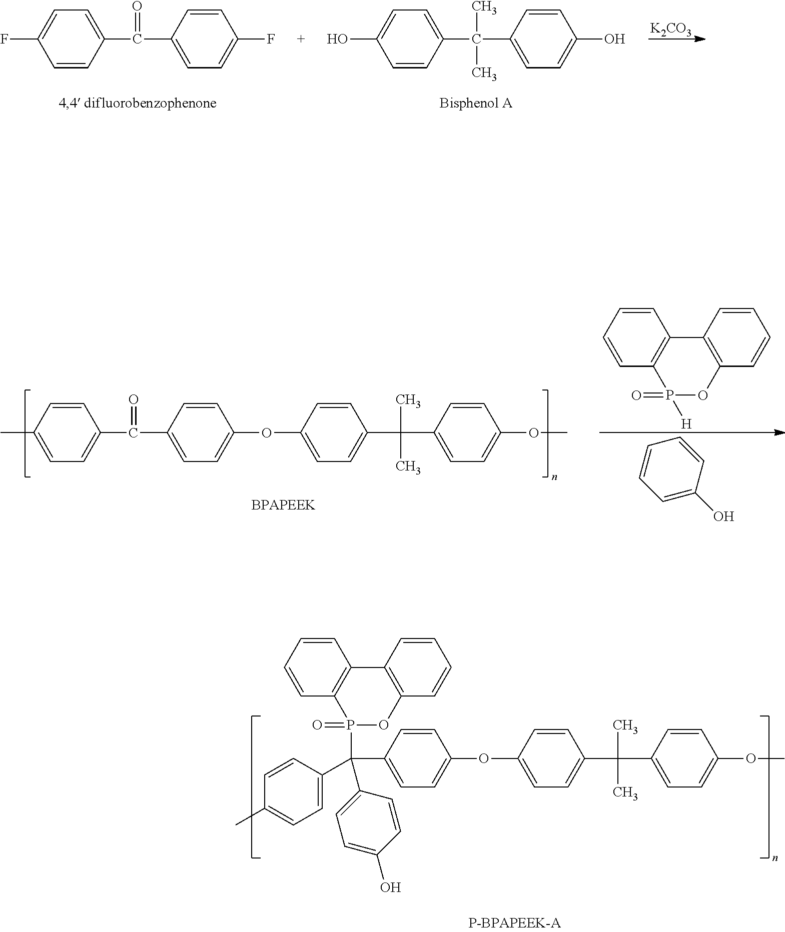

If the above poly(aryl ether ketone) is poly(ether ether ketone)(PEEK), the reaction scheme can be:

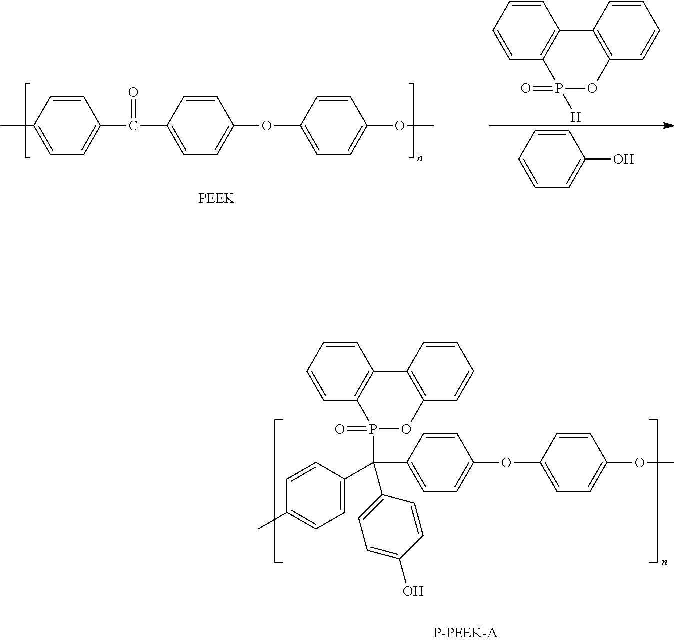

and the product is P-PEEK-A.

If a phosphorus-containing poly(aryl ether ketone) including NH₂ functional group (P-BPAPEEK-B) is desired, the process can include the steps of:
(1) reacting bisphenol-A with 4,4′-difluorobenzophenone to form BPAPEEK; and
(2) reacting BPAPEEK, DOPO, and excess aniline upon the catalysis of acids.
   The reaction scheme can be:

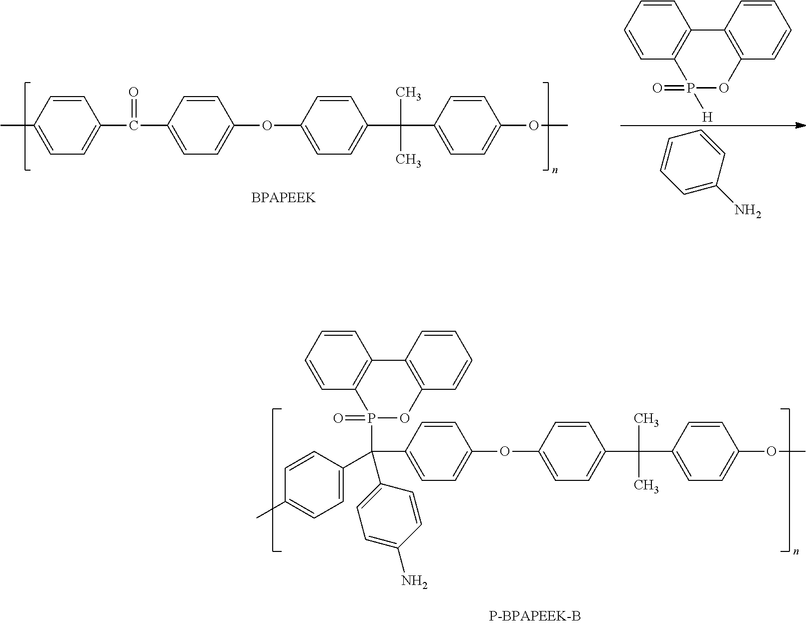

If the above poly(aryl ether ketone) is poly(ether ether ketone)(PEEK), the reaction scheme can be:

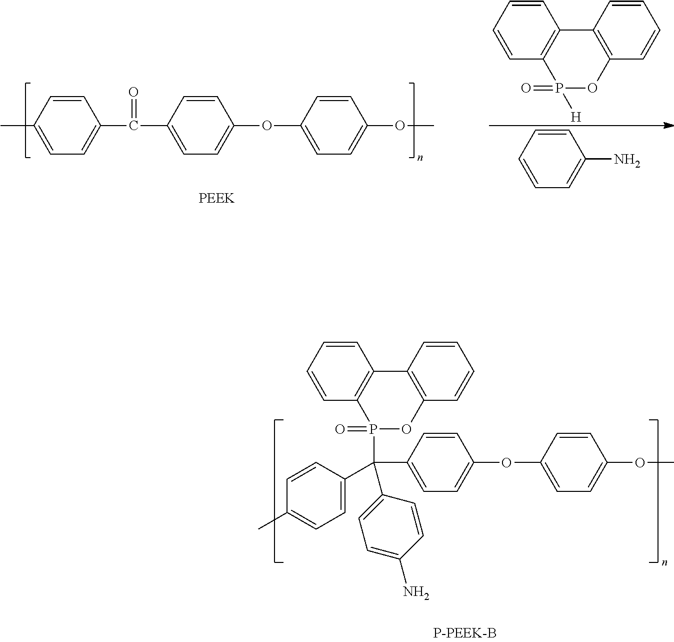

and the product is P-PEEK-B.

If a phosphorus-containing poly(aryl ether ketone) including OCH₃ group (P-BPAPEEK-C) is desired, the process can include the steps of:
(1) reacting bisphenol-A with 4,4′-difluorobenzophenone to form BPAPEEK; and
(2) reacting BPAPEEK, DOPO, and excess anisole upon the catalysis of acids to form P-BPAPEEK-C.
   The reaction scheme can be:

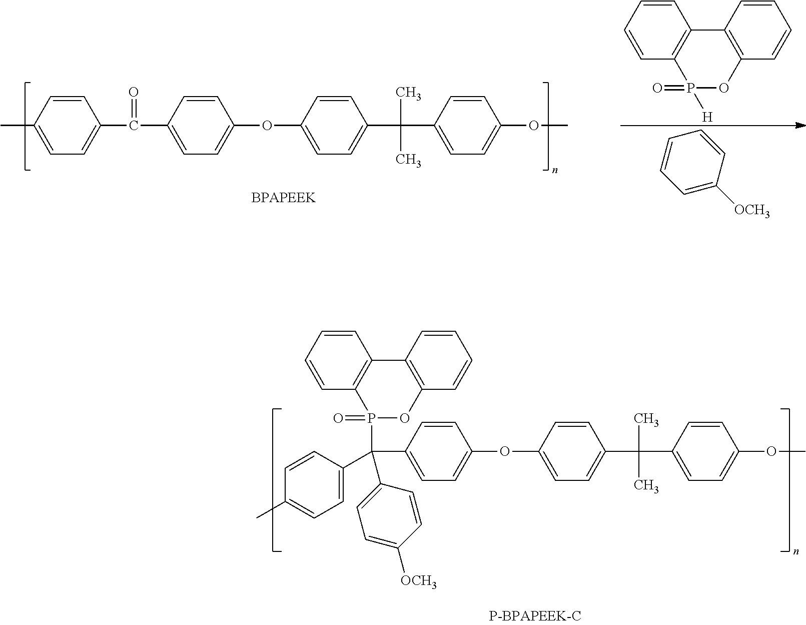

If the above poly(aryl ether ketone) is poly(ether ether ketone)(PEEK), the reaction scheme can be:

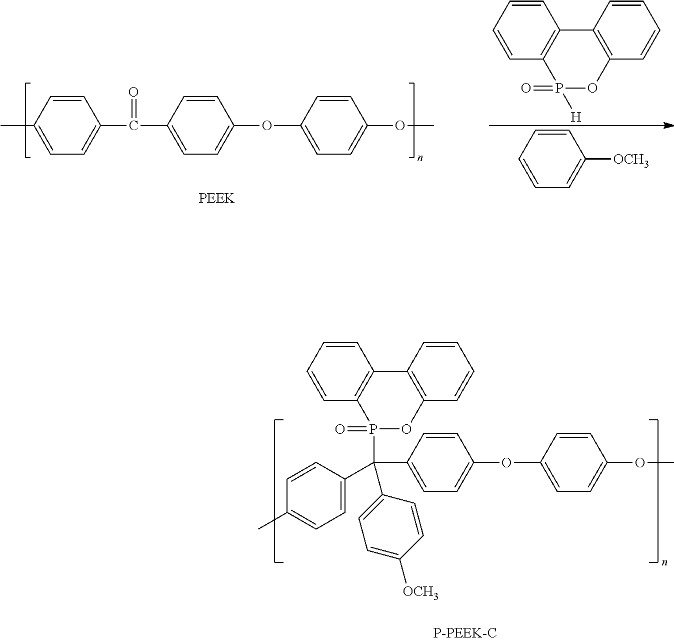

and the product is P-PEEK-C.
Partial Phosphorus-Functionalized Poly(aryl ether ketone)

The present invention not only can use DOPO to react all carbonyls of the poly(aryl ether ketone), but also can use DOPO to react portion of carbonyls to form partial phosphorus-functionalized poly(aryl ether ketone). In a relation to the categorization of the phosphorus-functionalized poly(aryl ether ketone) of formula (I) mentioned above, the partial phosphorus-functionalized poly(aryl ether ketone) can be categorized as series of Partial-P-BPAPEEK, Partial-P-PEEK, Partial-P-PEK, and Partial-P-PEKK. For example, in the compound of formula (I), if a=1, b=0, c=1,

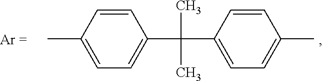

a partial carbonyl reacted poly(aryl ether ketone) can produce a phosphorus-functionalized poly(aryl ether ketone) of formula (VI), which can be named as Partial-P-BPAPEEK series. In the formula, 1<n₁<n; 1<n₂<n; and n₁+n₂=n.

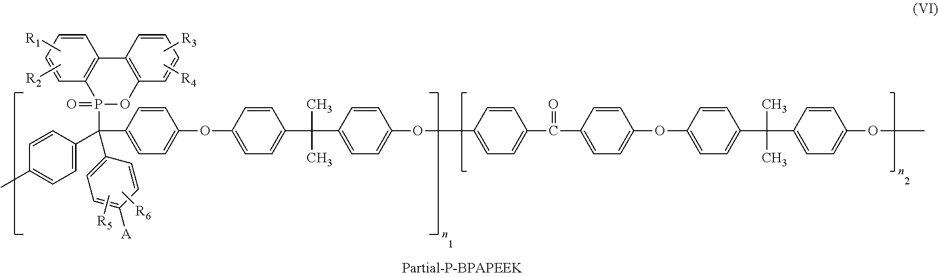

In the compound of formula (I), if a=1, b=0, c=1,

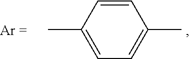

a partial carbonyl reacted poly(aryl ether ketone) can produce a phosphorus-functionalized poly(aryl ether ketone) of formula (VII), which can be named as Partial-P-PEEK series. In the formula, 1<n₁<n; 1<n₂<n; and n₁+n₂=n.

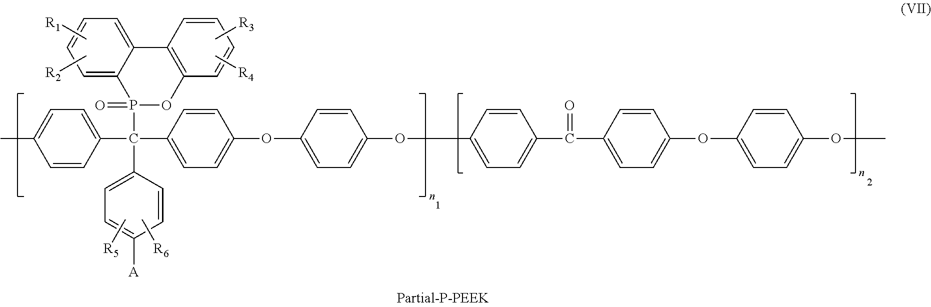

In the compound of formula (I), if a=1, b=0, c=0, a partial carbonyl reacted poly(aryl ether ketone) can produce a phosphorus-functionalized poly(aryl ether ketone) of formula (VIII), which can be named as Partial-P-PEK series. In the formula, 1<n₁<n; 1<n₂<n; and n₁+n₂=n.

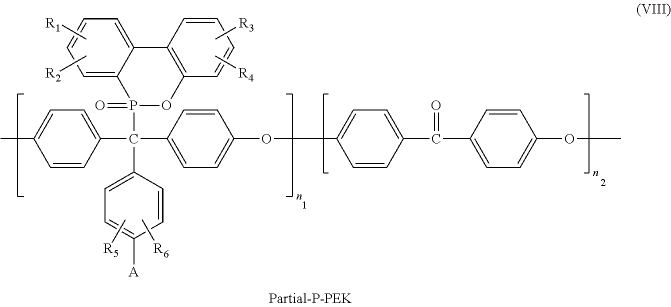

In the compound of formula (I), if a=1, b=1, c=0, a partial carbonyl reacted poly(aryl ether ketone) can produce a phosphorus-functionalized poly(aryl ether ketone) of formula (IX), which can be named as Partial-P-PEKK series. In the formula, 1<n₁<n; 1<n₂<n; 1<n₃<n; and n₁+n₂+n₃=n.

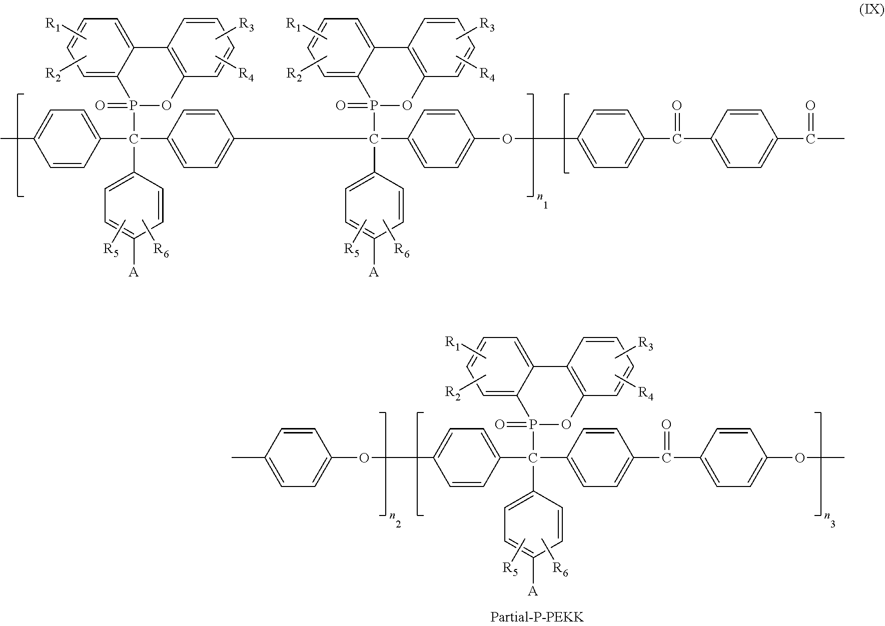

Process for Preparing A Partial Phosphorus-Functionalized Poly(aryl ether ketone)

The present invention provides a process for preparing the above partial phosphorus-functionalized poly(aryl ether ketone) of formula (VI), (VII), (VIII), or (IX), including: processing addition reaction through carbonyl of a poly(aryl ether ketone) polymer; and processing condensation reaction with a substituted or unsubstituted compound having phenyl ring upon catalysis of an acid to form the partial phosphorus-functionalized poly(aryl ether ketone) of formula (VI), (VII), (VIII), or (IX), whereby the functional groups are introduced into the polymer chain to form a polymer such as the compound of formula (VI), (VII), (VIII) or (IX) for further modifications.

The present invention further provides a process for preparing the partial phosphorus-functionalized poly(aryl ether ketone) of formula (VI), (VII), (VIII), or (IX), including reacting poly(aryl ether ketone) of formula (X), organic phosphide of formula (XI), a compound of formula (XII), and a catalyst to from the partial phosphorus-functionalized poly(aryl ether ketone) of formula (VI), (VII), (VIII), or (IX);

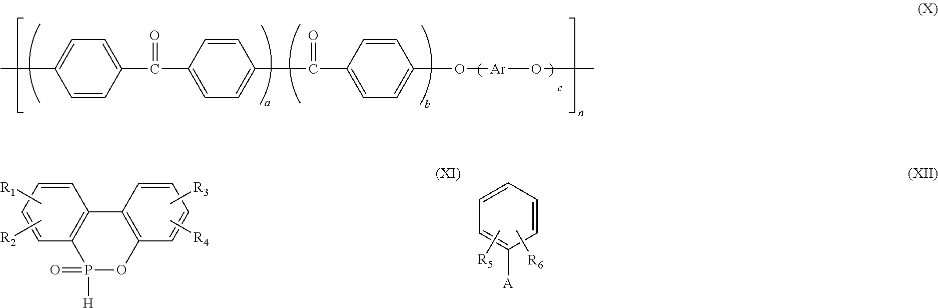

wherein a, b, c, n, Ar, R₁ to R₆, and A are defined as above.

The specific reaction schemes of the Partial-P-BPAPEEK series of formula (VI), the Partial-P-PEEK series of formula (VII), the Partial-P-PEK series of formula (VIII), the Partial-P-PEKK series of formula (V) of the partial phosphorus-functionalized poly(aryl ether ketone) are shown as follows respectively,

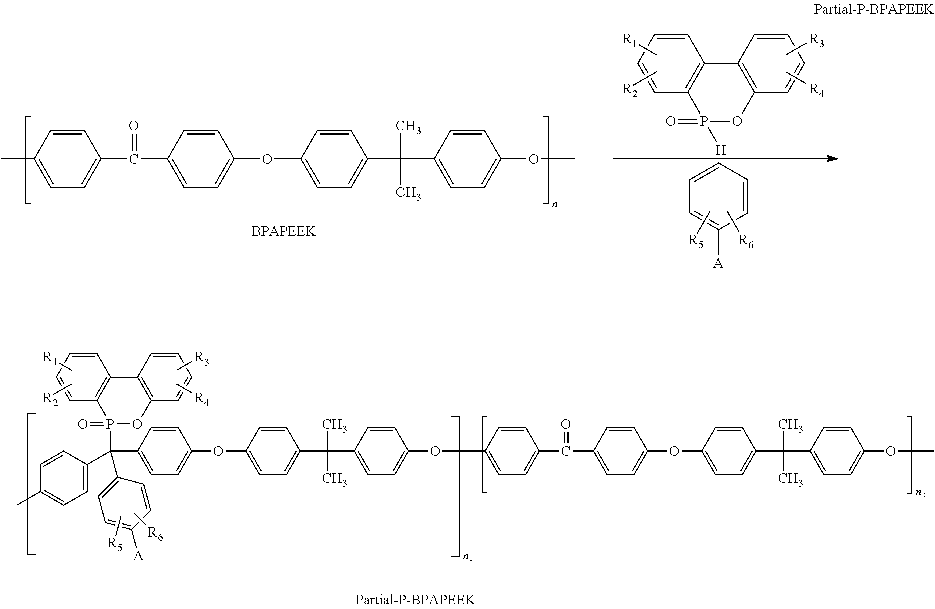

wherein 1<n₁<n; 1<n₂<n; and n₁+n₂=n;

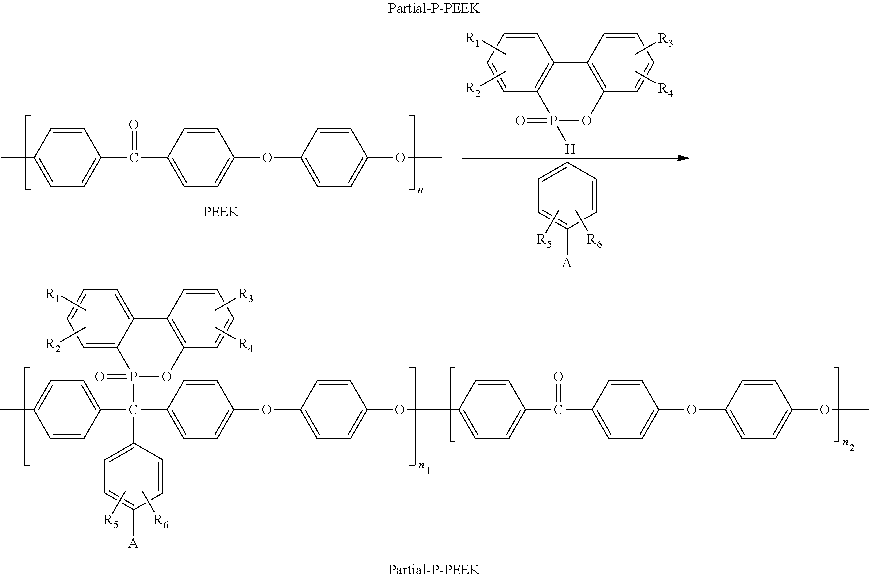

wherein 1<n₁<n; 1<n₂<n; and n₁+n₂=n;

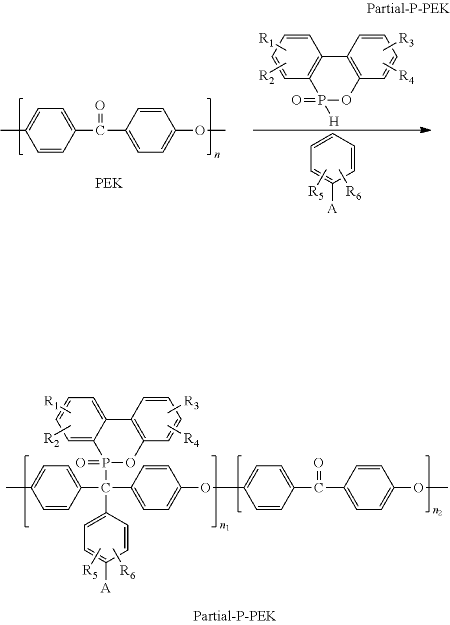

wherein 1<n₁<n; 1<n₂<n; and n₁+n₂=n; and

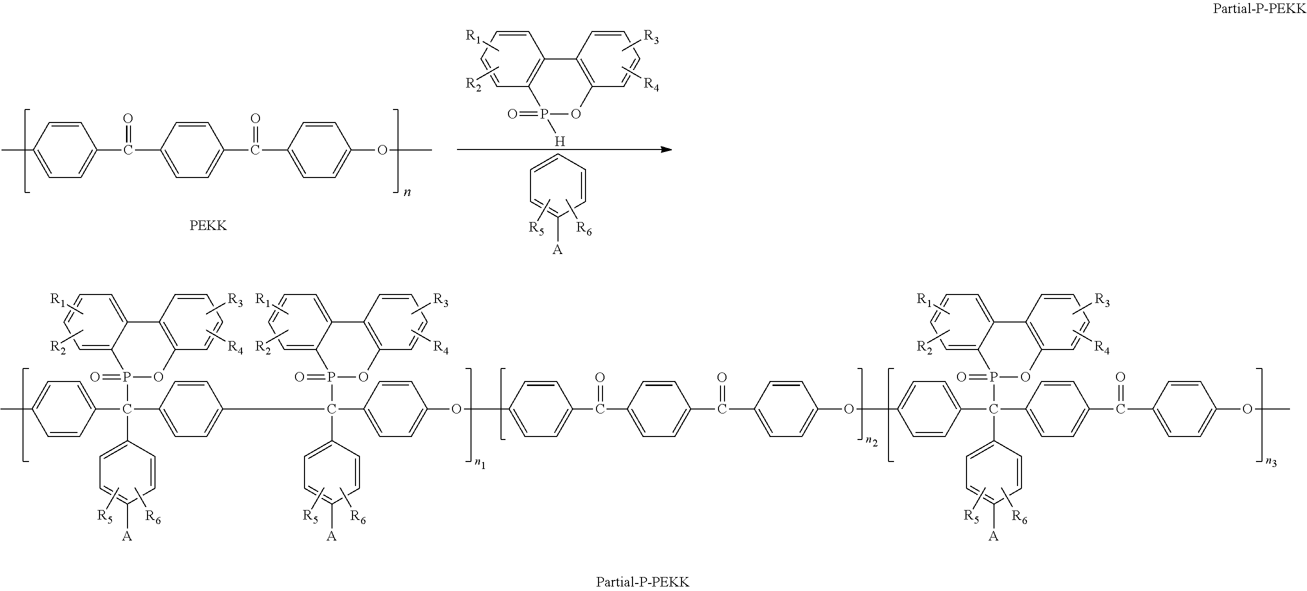

wherein 1<n₁<n; 1<n₂<n; 1<n₃<n; and n₁+n₂+n₃=n.

In the above structures, R₁ to R₆ and A are defined as above for the formula (I).

The acid catalyst used in the above reaction can be organic or inorganic acids such as acetic acid, toluene-p-sulfonic acid, methanesulfonic acid, sulfuric acid, orthanilic acid, 3-pyridinesulfonic acid, sulfanilic acid, hydrogen chloride (HCl), hydrogen bromide (HBr), hydrogen iodide (HI), hydrogen floride (HF), trifluoracetic acid (CF₃COOH), nitric acid (HNO₃), or phosphoric acid.

The above reaction can be carried out at a temperature about 105 to 155° C. The reaction time is about 10 to 14 hours.

In view of the above, since the precursor of the present invention is poly(aryl ether ketone) polymer, such as PEK, PEEK, or PEKK, the phosphorus-functionalized poly(aryl ether ketone) not only can provide specific functional groups for further modifications, but also can preserve the superior mechanical property and improved heat-resistant and flame-resistant properties as well.

### EXAMPLES

The following embodiments are used to further illustrate the present invention, but not intended to limit the scope of the present invention, and any modifications and variations achieved by those skilled in the art without departing from the spirit of the present invention will fall into the scope of the present invention.

### Example 1

### Synthesis of P-BPAPEEK-A

According to the present invention, synthesis of P-BPAPEEK-A polymer involves initiator DOPO, catalyst, solvent, and BPAPEEK polymer. The synthesis steps are as follows:

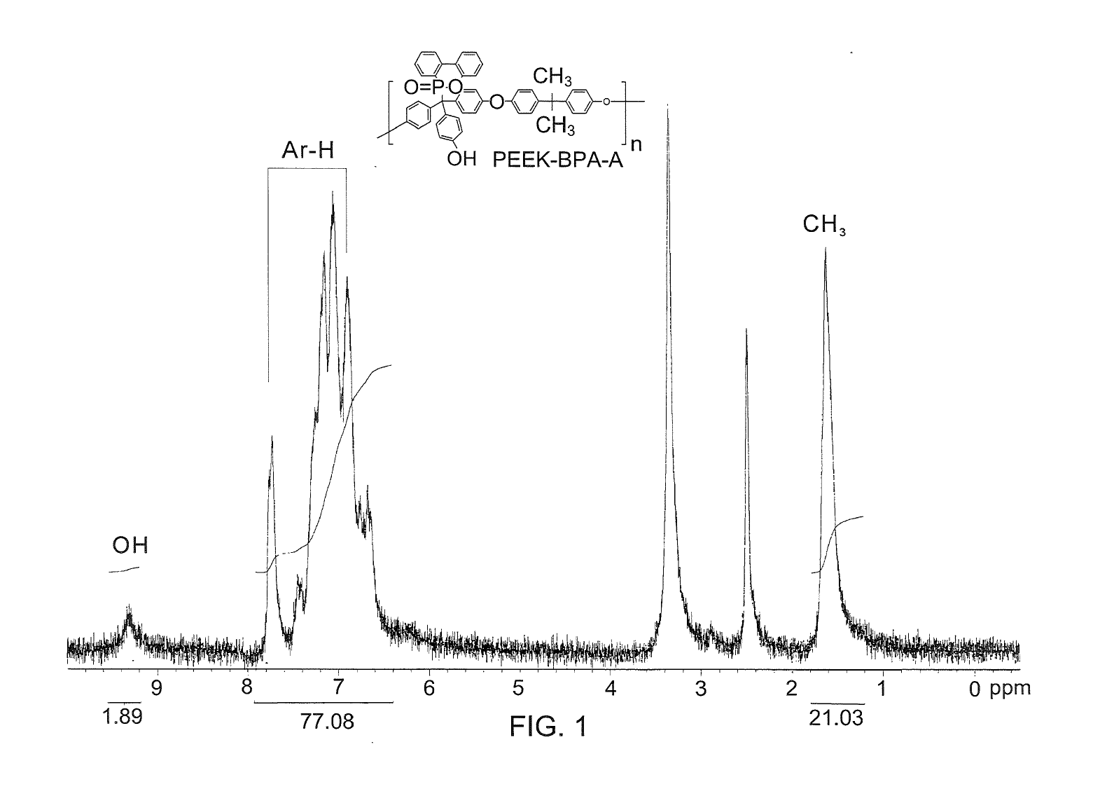

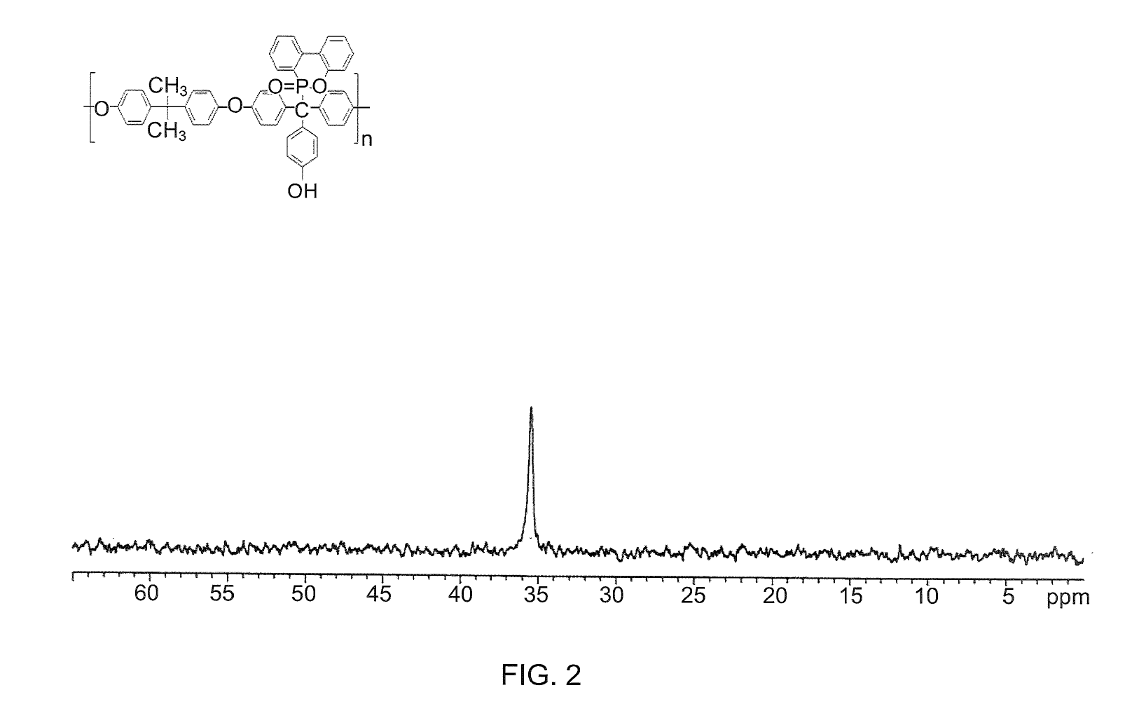

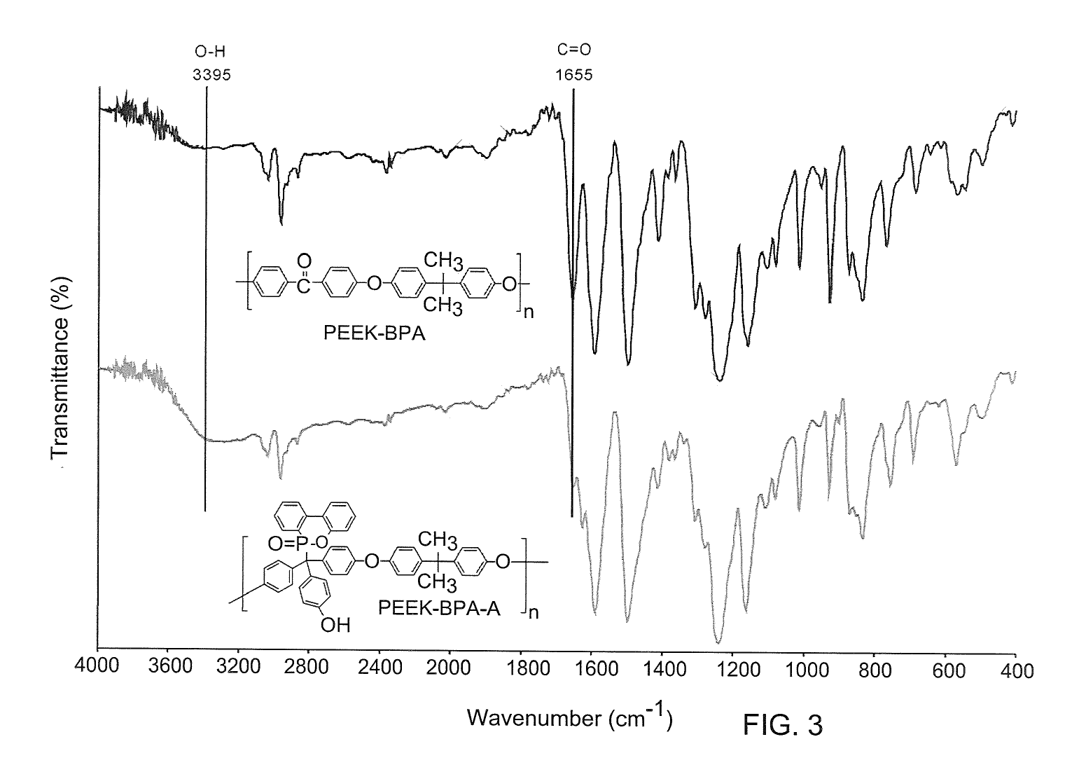

About 30 g (about 0.074 mol of repeating units) of BPAPEEK, about 15.95 g (about 0.074 mol) of DOPO, about 0.64 g (about 4 wt % of DOPO) of H₂SO₄, and about 69.46 g (about 0.738 mol) of phenol were added to a 100 ml reactor, and then the reaction temperature was raised to about 130° C. The reaction was continued for about 12 hours and then the stirring was stopped. The reactor was cooled to room temperature. The product was dropped into 500 ml methanol and red solid was precipitated after stirring, i.e. P-BPAPEEK-A. Then, the synthesized P-BPAPEEK-A was precipitated, filtered, cleaned with large amounts of methanol to remove the phenol residue and then baked at a temperature of about 110° C. in a vacuum oven after filtration, to get the product P-BPAPEEK-A. The yield was 90%. The NMR spectrum (H), NMR spectrum (P), and IR spectrum of P-BPAPEEK-A are shown in FIG. 1, FIG. 2, and FIG. 3 respectively.

### Example 2

### Synthesis of P-BPAPEEK-B

According to the present invention, synthesis of P-BPAPEEK-B polymer involves initiator DOPO, catalyst, solvent, and BPAPEEK polymer. The synthesis steps are as follows:

About 24.95 g (about 0.061 mol of repeating units) of BPAPEEK, about 13.27 g (about 0.061 mol) of DOPO, about 0.53 g (about 4 wt % of DOPO) of H₂SO₄, and about 57.09 g (about 0.613 mol) of aniline were added to a 100 ml reactor, and then the reaction temperature was raised to about 130° C. The reaction was continued for about 12 hours and then the stirring was stopped. The reactor was cooled to room temperature. The product was dropped into 500 ml methanol and red solid was precipitated after stirring, i.e. P-BPAPEEK-B. Then, the synthesized P-BPAPEEK-B was precipitated, filtered, cleaned with large amounts of methanol to remove the aniline residue and then baked at a temperature of about 110° C. in a vacuum oven after filtration, to get the product P-BPAPEEK-B. The yield was 84%.

### Example 3

### Synthesis of P-BPAPEEK-C

According to the present invention, synthesis of P-BPAPEEK-C polymer involves initiator DOPO, catalyst, solvent, and BPAPEEK polymer. The synthesis steps are as follows:

About 23 g (about 0.057 mol of repeating units) of BPAPEEK, about 12.23 g (about 0.057 mol) of DOPO, about 0.49 g (about 4 wt % of DOPO) of H₂SO₄, and about 61.21 g (about 0.566 mol) of anisole were added to a 100 ml reactor, and then the reaction temperature was raised to about 130° C. The reaction was continued for about 12 hours and then the stirring was stopped. The reactor was cooled to room temperature. The product was dropped into 500 ml methanol and red solid was precipitated after stirring, i.e. P-BPAPEEK-C. Then, the synthesized P-BPAPEEK-C was precipitated, filtered, cleaned with large amounts of methanol to remove the anisole residue and then baked at a temperature of about 110° C. in a vacuum oven after filtration, to get the product P-BPAPEEK-C. The yield was 81%.

### Example 4

### Synthesis of P-PEEK-A

According to the present invention, synthesis of P-PEEK-A polymer involves initiator DOPO, catalyst, solvent, and PEEK polymer. The synthesis steps are as follows:

About 24 g (about 0.083 mol of repeating units) of PEEK, about 18 g (about 0.083 mol) of DOPO, about 0.72 g (about 4 wt % of DOPO) of H₂SO₄, and about 78.3 g (about 0.832 mol) of phenol were added to a 100 ml reactor, and then the reaction temperature was raised to about 130° C. The reaction was continued for about 12 hours and then the stirring was stopped. The reactor was cooled to room temperature. The product was dropped into 500 ml methanol, stirred, and then solid was precipitated, i.e. P-PEEK-A. Then, the synthesized P-PEEK-A was precipitated, filtered, cleaned with large amounts of methanol to remove the phenol residue and then baked at a temperature of about 110° C. in a vacuum oven after filtration, to get the product P-PEEK-A. The yield was 92%.

### Example 5

### Synthesis of P-PEEK-B

According to the present invention, synthesis of P-PEEK-B polymer involves initiator DOPO, catalyst, solvent, and PEEK polymer. The synthesis steps are as follows:

About 26.95 g (about 0.093 mol of repeating units) of PEEK, about 20.21 g (about 0.093 mol) of DOPO, about 0.81 g (about 4 wt % of DOPO) of H₂SO₄, and about 96.61 g (about 0.93 mol) of aniline were added to a 100 ml reactor, and then the reaction temperature was raised to about 130° C. The reaction was continued for about 12 hours and then the stirring was stopped. The reactor was cooled to room temperature. The product was dropped into 500 ml methanol, stirred, and then red solid was precipitated, i.e. P-PEEK-B. Then, the synthesized P-PEEK-B was precipitated, filtered, cleaned with large amounts of methanol to remove the aniline residue and then baked at a temperature of about 110° C. in a vacuum oven after filtration, to get the product P-PEEK-B. The yield was 88%.

### Example 6

### Synthesis of P-PEEK-C

According to the present invention, synthesis of P-PEEK-C polymer involves initiator DOPO, catalyst, solvent, and PEEK polymer. The synthesis steps are as follows;

About 16.7 g (about 0.058 mol of repeating units) of PEEK, about 12.52 g (about 0.058 mol) of DOPO, about 0.501 g (about 4 wt % of DOPO) of H₂SO₄, and about 62.61 g (about 0.579 mol) of anisole were added to a 100 ml reactor, and then the reaction temperature was raised to about 130° C. The reaction was continued for about 12 hours and then the stirring was stopped. The reactor was cooled to room temperature. The product was dropped into 500 ml methanol, stirred, and then red solid was precipitated, i.e. P-PEEK-C. Then, the synthesized P-PEEK-C was precipitated, filtered, cleaned with large amounts of methanol to remove the anisole residue and then baked at a temperature of about 110° C. in a vacuum oven after filtration, to get the product P-PEEK-C. The yield was 83%.

1. A phosphorus-functionalized poly(aryl ether ketone) of general formula (I): 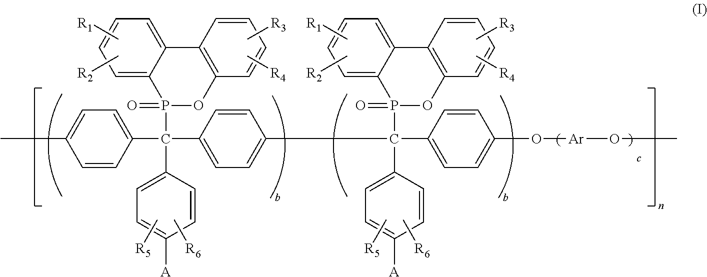
wherein a, b, c independently to each other is an integer of 0 to 3; n is an integer of 10 to 300;
Ar is di-substituted phenyl ring or naphthalene;
R₁ to R₆ independently to each other are selected from a group consisting of H, C₁-C₆alkyl, C₁-C₆alkoxy, C₃-C₇cycloalkyl, phenyl, nitro, phenoxy, C₁-C₁₀haloalkyl, —CF₃, —OCF₃, and halo atom;
A is selected from a group consisting of —OH, —NH₂, —OCH₃, C₁-C₆alkyl, C₁-C₆alkoxy, C₁-C₁₀haloalkyl, C₃-C₇cycloalkyl, —CF₃, —OCF₃, halo atom, —NHR₁, —NH(C═O)—R₁, —NH(O═C—O)—R₁, —NH(O═C—NH)—R₁, 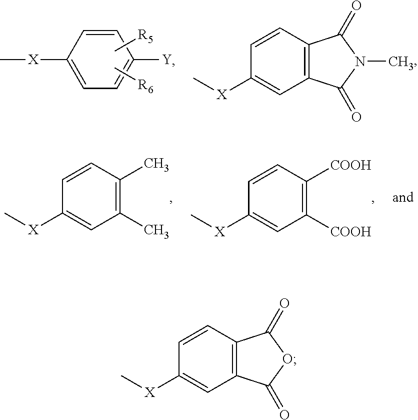
X is —O— or —NH—; and
Y is selected from a group consisting of hydrogen atom, —NO₂, —OH, —NH₂, —COOH, C₁-C₆alkyl, C₁-C₆alkoxy, C₃-C₇cycloalkyl, —CF₃, —OCF₃, and halo atom.

2. The phosphorus-functionalized poly(aryl ether ketone) of claim 1, wherein when a=1, b=0, c=1, and Ar is 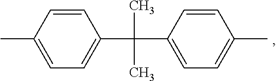
the compound of formula (I) is

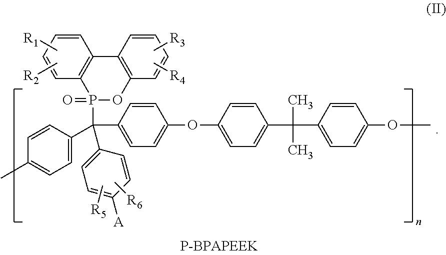

3. The phosphorus-functionalized poly(aryl ether ketone) of claim 1, wherein when a=1, b=0, c=1, and Ar is 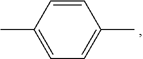
the compound of formula (I) is

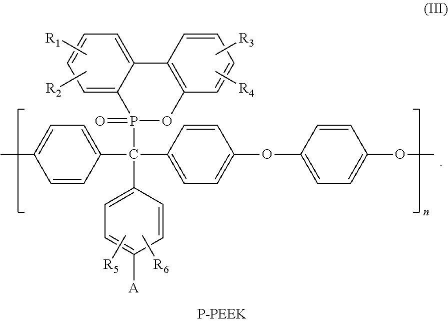

4. The phosphorus-functionalized poly(aryl ether ketone) of claim 1, wherein when a=1, b=0, and c=0, the compound of formula (I) is

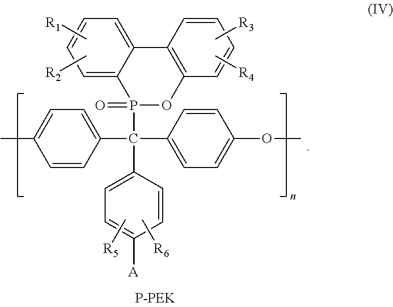

5. The phosphorus-functionalized poly(aryl ether ketone) of claim 1, wherein when a=1, b=1, and c=0, the compound of formula (I) is

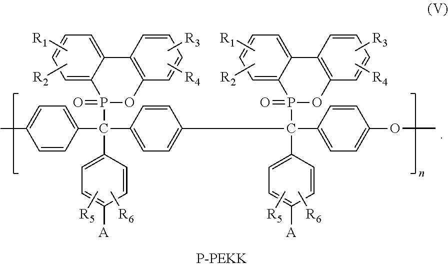

6. The phosphorus-functionalized poly(aryl ether ketone) of claim 2, wherein R₁ to R₆ are H, and
(a) if A is —OH, the compound of formula (II) is formula (P-BPAPEEK-A); or 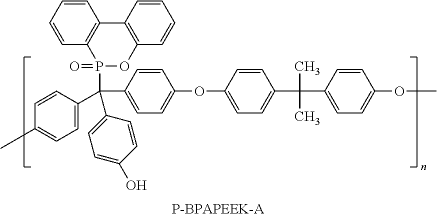
(b) if A is —NH₂, the compound of formula (II) is formula (P-BPAPEEK-B); or 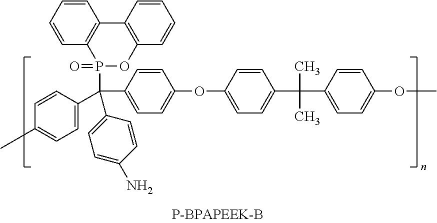
(c) if A is —OCH₃, the compound of formula (II) is formula (P-BPAPEEK-C)

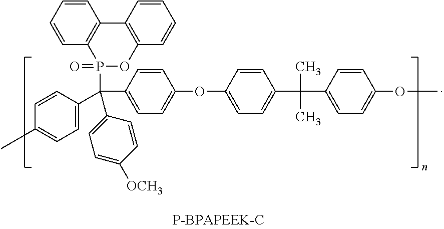

7. The phosphorus-functionalized poly(aryl ether ketone) of claim 3, wherein R₁ to R₆ are H, and
(a) if A is —OH, the compound of formula (III) is formula (P-PEEK-A); or 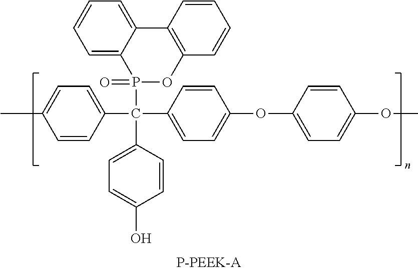
(b) if A is —NH₂, the compound of formula (III) is formula (P-PEEK-B); or 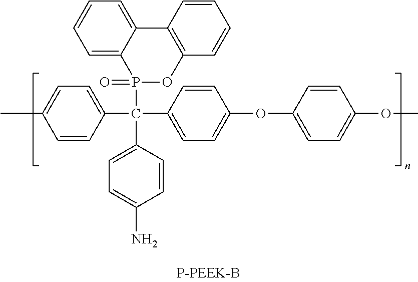
(c) if A is —OCH₃, the compound of formula (III) is formula (P-PEEK-C)

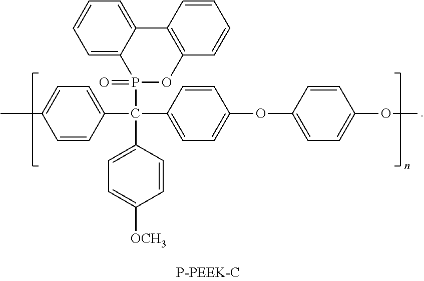

8. A process of preparing a phosphorus-functionalized poly(aryl ether ketone) of claim 1, including:
processing addition reaction through carbonyl of a poly(aryl ether ketone) polymer; and
processing condensation reaction with a substituted or unsubstituted compound having phenyl ring upon catalysis of an acid.

9. A process of preparing a phosphorus-functionalized poly(aryl ether ketone) of claim 1, including:
reacting poly(aryl ether ketone) of formula (X), organic phosphide of formula (XI), a compound of formula (XII), and a catalyst, 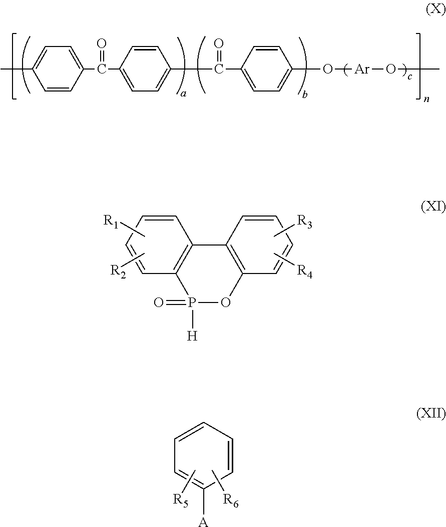
wherein a, b, c, n, Ar, R₁ to R₆, and A are as defined in claim 1.

10. The process of claim 8, wherein the poly(aryl ether ketone) is selected from the group consisting of

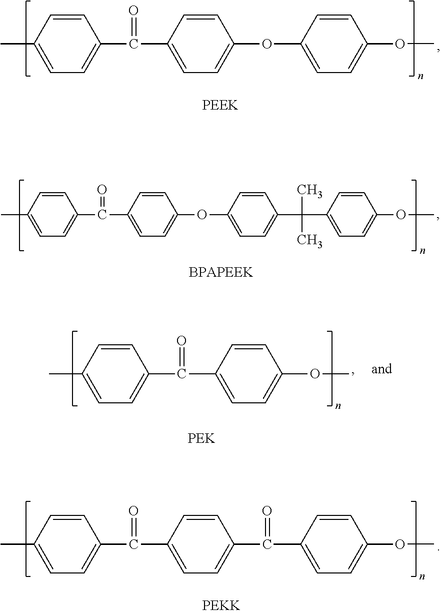

11. The process of claim 8, wherein the substituent of the compound having phenyl ring is selected from the group consisting of —OH, —NH₂, —OCH₃, C₁-C₆alkyl, C₁-C₆alkoxy, C₁-C₁₀haloalkyl, C₃-C₇cycloalkyl, —CF₃, —OCF₃, halo atom, —NHR₁, —NH(C═O)—R₁, —NH(O═C—O)—R₁, —NH(O═C—NH)—R₁, 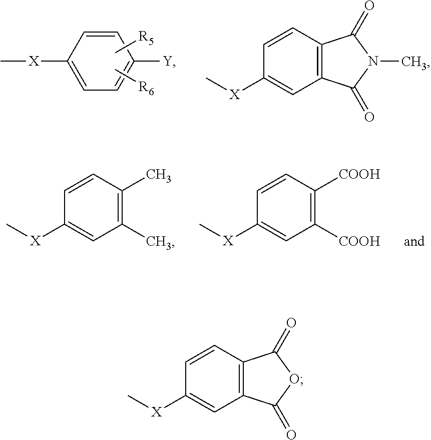
X is —O— or —NH—; and
Y is selected from a group consisting of hydrogen atom, —NO₂, —OH, —NH₂, —COOH, C₁-C₆alkyl, C₁-C₆alkoxy, C₃-C₇cycloalkyl, —CF₃, —OCF₃, and halo atom.

12. The process of claim 8, wherein the acid is selected from the group consisting of oxalic acid, acetic acid, p-toluenesulfonic acid, methanesulfonic acid, sulfuric acid, orthanilic acid, 3-pyridinesulfonic acid, sulfanilic acid, hydrogen chloride (HCl), hydrogen bromide (HBr), hydrogen iodide (HI), hydrogen floride (HF), trifluoracetic acid (CF₃COOH), nitric acid (HNO₃), phosphoric acid, and the mixture thereof.

13. The process of claim 8, wherein the reaction is carried out at a temperature of about 105 to 155° C. for about 10 to 14 hours.

14. A partial phosphorus-functionalized poly(aryl ether ketone) of general formula (VI): 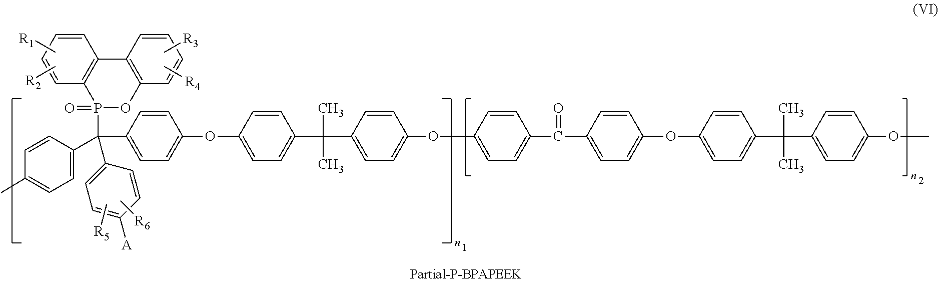
wherein 1<n₁<n; 1<n₂<n; and n₁+n₂=n.

15. A partial phosphorus-functionalized poly(aryl ether ketone) of general formula (VII): 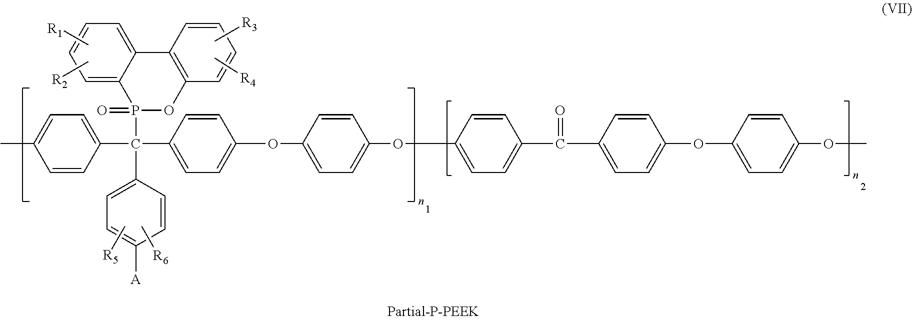
wherein 1<n₁<n; 1<n₂<n; and n₁+n₂=n.

16. A partial phosphorus-functionalized poly(aryl ether ketone) of general formula (VIII): 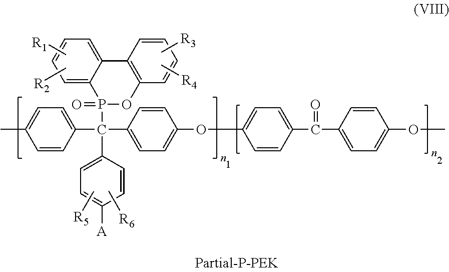
wherein 1<n₁<n; 1<n₂<n; and n₁+n₂=n.

17. A partial phosphorus-functionalized poly(aryl ether ketone) of general formula (IX): 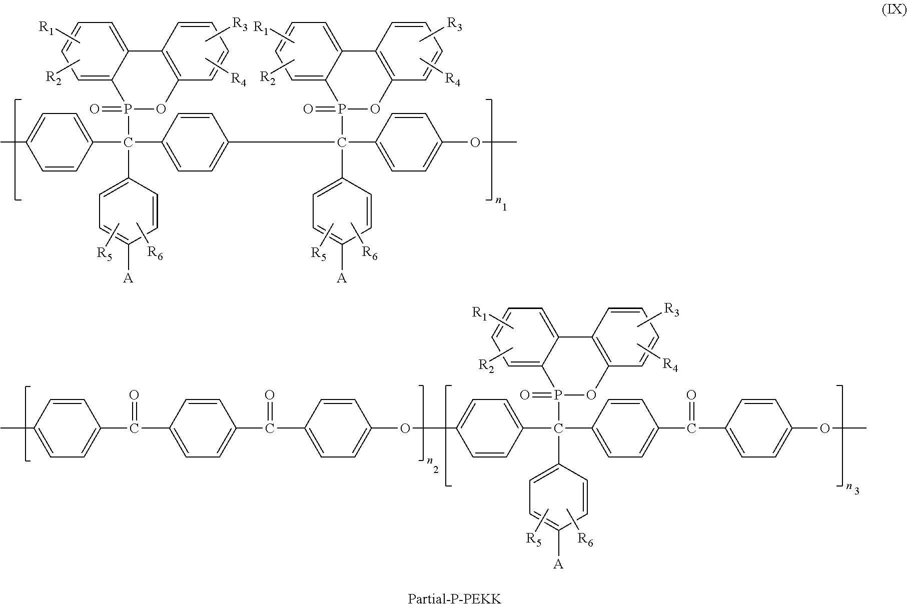
wherein 1<n₁<n; 1<n₂<n; 1<n₃<n; and n₁+n₂+n₃=n.

18. A process of preparing a partial phosphorus-functionalized poly(aryl ether ketone) of claim 14, including:
processing addition reaction through carbonyl of a poly(aryl ether ketone) polymer; and
processing condensation reaction with a substituted or unsubstituted compound having phenyl ring upon catalysis of an acid.

19. A process of preparing a partial phosphorus-functionalized poly(aryl ether ketone) of claim 14, including:
reacting poly(aryl ether ketone) of formula (X), organic phosphide of formula (XI), a compound of formula (XII), and a catalyst, 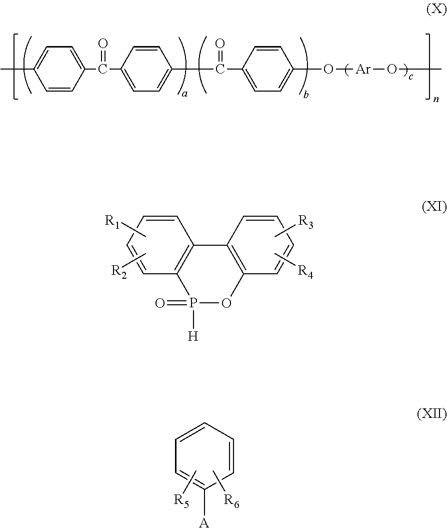
wherein a, b, c, n, Ar, R₁ to R₆, and A are as defined in claim 1.

20. The process of claim 18, wherein the poly(aryl ether ketone) is selected from the group consisting of

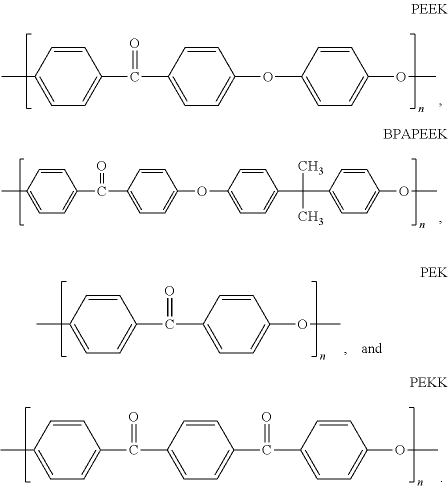

21. The process of claim 18, wherein the substituent of the compound having phenyl ring is selected from the group consisting of —OH, —NH₂, —OCH₃, C₁-C₆alkyl, C₁-C₆alkoxy, C₁-C₁₀haloalkyl, C₃-C₇cycloalkyl, —CF₃, —OCF₃, halo atom, —NHR₁, —NH(C═O)—R₁, —NH(O═C—O)—R₁, —NH(O═C—NH)—R₁, 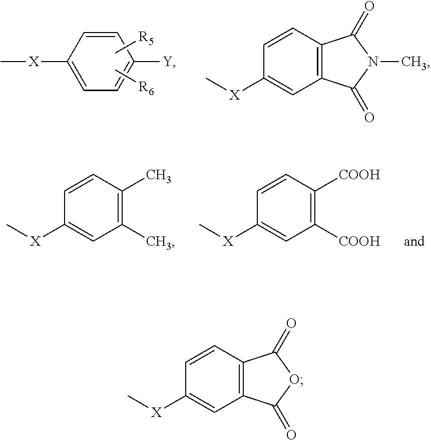
X is —O— or —NH—; and
Y is selected from a group consisting of hydrogen atom, —NO₂, —OH, —NH₂, —COON, C₁-C₆alkyl, C₁-C₆alkoxy, C₃-C₇cycloalkyl, —CF₃, —OCF₃, and halo atom.

22. The process of claim 18, wherein the acid is selected from the group consisting of oxalic acid, acetic acid, p-toluenesulfonic acid, methanesulfonic acid, sulfuric acid, orthanilic acid, 3-pyridinesulfonic acid, sulfanilic acid, hydrogen chloride (HCl), hydrogen bromide (HBr), hydrogen iodide (HI), hydrogen floride (HF), trifluoracetic acid (CF₃COOH), nitric acid (HNO₃), phosphoric acid, and the mixture thereof.

23. The process of claim 18, wherein the reaction is carried out at a temperature of about 105 to 155° C. for about 10 to 14 hours.

24. A use of the phosphous-functionalized poly(aryl ether ketone) of claim 1 in the flame-resistant material, preferably in the field of wire packaging.

25. A use of the partial phosphous-functionalized poly(ether ketone) of claim 14 in the flame-resistant material, preferably in the field of wire packaging.
